(19) United States
(12) Patent Application Publication
(10) Pub. No.: US 2005/0220978 A1
(43) Pub. Date: Oct. 6, 2005

(54) Dispersible protein composition

(75) Inventors: Ravindra L. Arudi, Woodbury, MN (US); Michael A. Porter, Maple Grove, MN (US)

Correspondence Address: Edward L. Levine;Cargill, Incorporated, P.O. Box 5624, Minneapolis, MN, 55440-5624, US

(73) Assignee: Cargill, Incorporated

(21) Appl. No.: 10/814,434

(22) Filed: Mar. 31, 2004

(51) Int. Cl. A23J 1/00

(52) U.S. Cl. 426/656

(57) ABSTRACT

The subject matter described herein relates to compositions with high protein concentrations that can be readily dispersed in aqueous liquids. The compositions include protein and a surfactant such as hydroxylated lecithin, which assists in readily dispersing the composition in aqueous liquids. A method for making the composition is disclosed which includes spraying the protein with an aqueous solution that includes the surfactant.

### BACKGROUND

Proteins are complex macromolecules that are fundamental to life. Much of the cellular content of plants and animals is protein, and metabolism is dependent on protein enzymes. Because of the fundamental role that protein plays in living things, it is often added to food and animal feed (i.e., edible materials) to supplement natural sources of protein. Adding protein to edible materials provides a number of desirable effects such as assisting the growth of additional muscle mass.

Although a variety of suitable proteins may be added to edible materials, protein from widely available sources such as soybeans are most often used. Soy protein is particularly desirable due to its low price, high quantity, and high quality. For processing and handling purposes, powdered soy protein is often preferred over liquid soy protein, such as soy milk. The soy protein powder can be added to various edible material to created a protein supplemented edible material.

Unfortunately, the use of soy protein powder has a number of drawbacks. For example, soy protein powder does not readily disperse in liquids (e.g., water, water based liquids, high polarity edible liquids, etc.). When soy protein powder is added to a liquid, it often forms clumps, lumps, or masses having a hydrated outer layer and a dry inner layer. These clumps may commonly be referred to as “fish eyes.” In some instances, the clumps remain even after vigorous agitation or mixing of the soy protein powder and the liquid. The clumps, if not removed, make the edible liquid material much less appealing to consume. Also, even if the clumps can be removed by mixing, long mixing times eat away at processing efficiency thus increasing the overall cost of the resulting edible material.

Surfactants, such as lecithin, have been used in an attempt to increase the dispersibility of the soy protein powder. It has been commonly thought that the use of a low polarity, hydrophobic, oily lecithin material provides the most suitable dispersion properties for the soy protein powder. The oil (e.g., vegetable oil) is used as a carrier for the powdered lecithin as it is applied to the soy protein powder. The oil also serves to lower the HLB value of the oily lecithin material. The use of oily lecithin material results in creating a residual oily layer on the protein particles. The residual oil may interfere with the free flow of the soy protein powder. Also, the residual oil can be subject to oxidation, leading to the development of rancid odors and flavors that are often incompatible with high quality edible materials. In many instances, it is undesirable to blend lecithin with non-lecithin components (e.g., carbohydrates, silica-type flow agents, etc.) because these components may dilute the protein content, add haze/turbidity, and adversely affect the overall taste/palatability as well as the nutritional (caloric/glycemic) value.

Accordingly, it would be desirable to provide an improved protein composition that has one or more desirable properties such as easy flowability, stability to oxidative degradation, emulsifying/foaming properties, and the ability to more easily disperse in liquids such as water or other polar materials (e.g., polar edible materials).

### SUMMARY

The present application relates to compositions with high protein concentrations that can be readily dispersed in aqueous liquids. A dispersible protein composition is described herein which includes at least about 80 wt % (all percentages referred to herein are on a dry solids basis unless noted otherwise) protein and a surfactant as well as having a dispersibility index of no more than about 30 seconds. The dispersible protein composition typically includes no more than about 0.7 wt % crude fiber, or, desirably, no more than about 0.5 wt % crude fiber. In one example, the dispersible protein composition may have a pile apex angle of at least about 93 degrees, or, desirably, at least about 95 degrees. In another example, the dispersible protein composition may have a pile spread diameter of at least about 87 mm, or, desirably, at least about 90 mm.

Examples of suitable protein include whey protein, soy protein, wheat protein, lupin, corn gluten, and/or mixtures thereof. The protein is commonly employed in particulate form, e.g., as particulate protein material with a mean particle size of about 10 microns to 500 microns, or, desirably, about 25 microns to 500 microns. Quite commonly, the protein material has a mean particle size of about 50 microns to 400 microns. In one embodiment, the protein includes at least 75 wt % whey protein, soy protein, wheat protein, lupin, corn gluten, and mixtures thereof

The surfactant may be selected from a number of edible or food grade surfactants. For example, the surfactant may include lecithin material. The surfactant may also include hydroxylated lecithin. The surfactant may have a peak oxidative exotherm index of at least about 12 minutes, or, desirably, at least about 15 minutes. The surfactant may also have a surface tension index of at least about 30 dynes/cm, or, desirably, at least about 35 dynes/cm. As used herein, the term “surface tension index” refers to the surface tension as measured in accordance with Example 1 using an aqueous solution of 2 wt % surfactant. In addition, the surfactant may have an HLB value of at least about 9. Moreover, the surfactant may include no more than about 8 wt % oil, or, desirably, no more than about 5 wt % oil.

Also described herein is a method of preparing the dispersible protein composition. The method may include one or more of the steps of fluidizing a particulate protein material, spraying the particulate protein material with a surfactant solution to provide a wetted protein composition, drying the wetted protein composition to provide an intermediate protein composition, and fluidizing the intermediate protein composition to provide the dispersible protein composition. The temperature of the particulate protein material may be maintained at no more than about 40° C., or, desirably, 35° C. The surfactant solution may be an aqueous solution that includes at least about 5 wt % surfactant. The moisture content of the fluidized particulate protein material may be at least about 8 wt %.

Use of the protein composition described herein can facilitate the timely dispersion of supplemental protein in a liquid (e.g., an aqueous solution). In addition, various embodiments also describe a dispersible protein composition that is easily flowable and resistant to oxidation. This allows the dispersible protein composition to be stored for longer periods of time and to be more easily handled and transported.

### DRAWINGS

FIG. 1 is a graph showing the oxidative exotherms for samples of unmodified lecithin material and hydroxylated lecithin material.

FIG. 2 is a picture of a pile of one embodiment of the dispersible protein material.

FIG. 3 is a picture of a pile of commercially available Supro 670.

### DETAILED DESCRIPTION

The subject matter described herein generally relates to readily dispersible protein powders and to a method of producing the same. In general, the dispersible protein composition includes protein and a surfactant which assists in providing the desirable dispersibility properties of the protein composition.

The protein used in the composition may include any animal and/or plant proteins. In particular, the protein used herein can be derived from any soluble protein source such as whey, wheat, soy, or other vegetable or animal source. Various methods for the isolation of the protein can be used. However, any reference to a particular type of protein (e.g., whey protein, soy protein, wheat protein, etc.) should be understood to refer to both the unmodified form of the protein as it exists at the source (e.g., in the plant, etc.) and to protein that may have been fractionated, hydrolyzed, or otherwise modified during the course of isolating and processing the protein. In many instances, it is desirable to use a water soluble and/or dispersible protein. A water soluble/dispersible protein may be inherently water soluble/dispersible or may be made water soluble/dispersible by the addition of a surfactant.

In one embodiment, the protein for the dispersible protein composition may include whey protein, soy protein, wheat protein, lupin, corn gluten, sodium caseinate, or a mixture thereof. In one embodiment, the protein in the dispersible protein composition may include at least about 50 wt %, or, desirably, 75 wt % whey protein, soy protein, wheat protein, lupin, corn gluten, sodium caseinate, or a mixture thereof. In another embodiment, the protein includes soy protein (e.g., at least about 75 wt % of the total protein is soy protein). The use of soy protein is often preferred due to commercial availability and cost. In yet another embodiment, the protein may be obtained from soy protein isolate (i.e., protein derived from soy that has a protein content of at least 90 wt %).

The surfactant or emulsifier used in the dispersible protein composition may be any of a number of suitable surfactants. One of the features of surfactants is that they lower the surface tension of water and thus enable water to spread into thinner layers more quickly. When surfactants are coated onto solids particles, water can hydrate the surface of those particles more quickly. In one embodiment, the surfactant is edible so that at the levels described herein it is suitable for digestion without significant adverse side effects. Examples of surfactants that may be used include lecithin material, sorbitan esters, propylene glycol esters, sugar esters, monoglycerides, diglycerides, polyglycerol esters, polysorbates, sodium stearoyl lactylate, hydrocolloids/gums, cellulose derivatives, maltodextrins, and mixtures thereof.

The foaming/emulsifying properties of the dispersible protein composition can be adjusted by manipulating the surface tension of the surfactant used in the composition. In various embodiments, the surfactant has a surface tension index of at least about 30 dynes/cm, or, desirably, at least about 35 dynes/cm, or, suitably, at least about 37 dynes/cm. In yet further embodiments, the surface tension index of the surfactant can be any value between about 30 dynes/cm and about 70 dynes/cm, or, desirably, between about 30 dynes/cm and about 50 dynes/cm.

The surfactant may also be described with reference to its hydrophobic-lipophilic balance (HLB) number. The HLB number correlates roughly with the solubility of the surfactant in water, with more water soluble materials typically having a higher HLB value. In one embodiment, the surfactant includes no more than about 5 wt % oil and has an HLB number of at least about 9, or, desirably, at least about 10.

The oxidative stability of a surfactant may be referenced to provide an indication of how susceptible the surfactant is to oxidation. With reference to Example 9, in one embodiment, the oxidative induction index for a suitable surfactant which includes no more than about 5 wt % oil is at least about 10 minutes, or, desirably, at least about 12 minutes, or, suitably, at least about 15 minutes. In another embodiment, the peak oxidative exotherm index for a surfactant which includes no more than about 5 wt % oil is at least about 15 minutes, or, desirably, at least about 18 minutes, or, suitably, at least about 20 minutes.

For reasons relating to cost and commercial availability, lecithin material derived from plant sources is a particularly suitable source of the surfactant. As used herein “lecithin material” refers to crude and purified mixtures of phosphatidyl esters and/or phosphatidic acids having a composition similar to the mixtures of neutral and polar lipids obtained as a by-product in the refining of vegetable oils. In addition to including at least 50 wt % acetone-insoluble phosphatides, lecithin material may also include various amounts of triglycerides, fatty acids, and carbohydrates. The term “lecithin material” as used herein is not limited to phospholipids from any specific source nor is it meant to refer specifically to the chemical compound phosphatidylcholine. Examples of lecithin material suitable for use in the dispersible protein composition include lecithin materials derived from soybean, cotton seed, corn, canola, sunflower, linseed, peanut, palm, palm kernel, and mixtures thereof. The term lecithin material is intended to include, but not be limited to, unmodified or standard lecithin, standard fluid grade lecithin (e.g., at least about 35 wt % oil), deoiled lecithin (e.g., no more than about 5-8 wt % oil), modified lecithin (e.g., chemically modified lecithin such as by way of acetylation, hydroxylation, acetylation/hydroxylation, sulfonation, epoxidation, phosphorylation, etc.; enzyme modified lecithin, etc.), etc. In one embodiment, the lecithin material includes no more than about 5 wt % oil.

As used herein, “hydroxylated lecithin material” refers to any lecithin material which includes phospholipids in which the lipid side chain(s) have been hyroxylated including lecithin material that is previously or subsequently modified (e.g., acetylated/hydroxylated or hydrolyzed/hydroxylated lecithin material, etc.). Also, as used herein, the term “lecithin” refers to phospholipids and the term “hydroxylated lecithin” refers to lecithin in which the side chain(s) have been hydroxylated including lecithin that is previously or subsequently modified (e.g., acetylated/hydroxylated lecithin, etc.).

In general, the phospholipids in the lecithin material are a class of compounds that display amphipathic characteristics. Amphipathic behavior is used to describe a material that can form stable interactions with both hydrophilic (water “loving”) and hydrophobic (water “fearing”) materials. In phospholipids, the phosphatidyl ester may engage in hydrophilic interactions and the remaining diglyceride backbone may engage in hydrophobic interactions. As a consequence of this mixed behavior, lecithin material is able to position itself at the interface between aqueous (hydrophilic) and oily (hydrophobic) materials.

In more specific terms, lecithin material may be obtained in many forms. Approximately twelve common natural forms of lecithin material have been observed. In commercial practice, products like soy lecithin material comprises primarily 3 or 4 of the possible forms and are commonly sold as unfractionated mixtures. Lecithin material from different sources may comprise different mixtures. The properties of these mixtures can be modified by chemical and/or enzymatic treatments to alter the hydrophilic-hydrophobic balance as desired for the final intended use. One example of such a modification is oxidation with oxygen, which ultimately results in a lecithin that contains hydroxyl groups on the lipid side chains of the diglyceride moiety. This decreases the hydrophobicity of the lecithin and increases the overall polarity of the molecule.

In one embodiment, the lecithin material used in the dispersible protein composition can be characterized as having high polarity, high water-solubility, low-shear viscosity, and/or high surface tension. Examples of such materials include hydroxylated lecithin material, acetylated lecithin material, etc. Lecithin material having these characteristics can be made by a process which includes one or more of the known methods of modifying lecithin materials (e.g., physical, chemical, enzymatic, irradiation, etc.). Physical modification refers to blending or co-extruding lecithin materials of different characteristics to provide the desired resulting characteristics. Exposure to high-energy ionizing radiation such as cobalt-60 gamma rays, X-rays and electron beams or to UV radiation in the presence of photosensitizers and oxygen or other atmospheres, may also be used to produce new lecithin materials characterized by high polarity, high water-solubility, low low-shear viscosity and high surface tension.

In one embodiment, the lecithin material may be hydroxylated soy lecithin material. While not wishing to be bound by theory, proteins properly coated with hydroxylated lecithin material may likely be less colored and less prone to oxidative degradation due to reduced unsaturation in the lipid portion compared to unmodified commercial soy lecithin material. Hydroxylated lecithin material may also be expected to aid in stronger interaction with water and other polar food ingredients (sugars, hydrocolloids, etc) via hydrogen-bonding, thereby potentially providing the dispersible protein composition with the ability to disperse quickly in polar liquids.

The dispersible protein composition may comprise a variety of components. For example, in one embodiment, the dispersible protein composition may comprise at least about 80 wt % protein, or, desirably, at least about 85 wt % protein, or, suitably, at least about 90 wt % protein. In another embodiment, the dispersible protein composition may comprise no more than about 10 wt % lecithin material, or, desirably, nor more than about 5 wt % lecithin material, or, suitably, no more than about 3 wt % lecithin material. In yet another embodiment, the dispersible protein composition may comprise no more than about 0.7 wt % crude fiber, or, desirably, no more than about 0.5 wt % crude fiber. Commonly, the dispersible protein composition may comprise no more than about 0.5 wt % of not readily digestible carbohydrates.

The dispersibility of the protein composition may be determined with reference to the dispersibility index as described in Example 3. Providing a protein composition that is more readily dispersible in water and other liquids may decrease the costs associated with processing the preparing edible materials that incorporate the protein composition due to decreased throughput times. The dispersible protein composition may have a dispersibility index that varies widely based on the particular combination of proteins and surfactant. For example, the protein composition may have a dispersibility index of no more than about 50 seconds, or, desirably, no more than about 30 seconds, or, suitably no more than about 12 seconds. In another embodiment, the protein composition may have a dispersibility index anywhere between about 1 second and about 50 seconds.

The flow characteristics of the dispersible protein composition may also be described by reference to the pile spread diameter and the pile apex angle (Example 10). In one embodiment, the dispersible protein composition may have a pile spread diameter of at least about 87 mm, or, desirably, at least about 90 mm, or, suitably, at least about 92 mm. In another embodiment, the dispersible protein composition may have a pile apex angle of at least about 93 degrees, or, desirably, at least about 95 degrees, or suitably, at least about 98 degrees. In addition, the mean particle size of the dispersible protein composition may be at least about 50 microns, or, desirably, at least about 100 microns. The mean particle size of the dispersible protein composition may be between about 10 microns and about 1000 microns, or, desirably, between about 25 microns and about 500 microns, or, suitably, between about 50 microns and about 400 microns, or, even more suitably, between about 25 microns and about 250 microns.

The dispersible protein composition may be made according to conventional techniques such as spray coating using, for example, a fluidized bed. The fluidized bed creates a suspension state of the particulate protein material in a stream of gas. When the protein materials are suspended in this manner, an aqueous solution comprising the surfactant is sprayed on the protein material particles. Once the desired amount of surfactant is applied, the resulting protein composition is dried.

The solution sprayed on the protein material may have various concentrations of surfactant. In one embodiment, the solution is an aqueous solution. However, in other embodiments the solution may comprise any suitable carrier or solvent for the surfactant (e.g., lecithin material). In one embodiment, the solution is an aqueous solution comprising between about 0.25 wt % surfactant and about 35 wt % surfactant. In another embodiment, the solution is an aqueous solution comprising between about 5 wt % and about 25 wt % surfactant, or, desirably, between about 5 wt % and about 15 wt % surfactant. In yet another embodiment, the solution may comprise at least about 1 wt %, 2 wt %, 5 wt %, or 10 wt % of the surfactant.

In certain embodiments, the use of a surfactant solution comprising relatively high concentrations of the surfactant may be desirable to reduce the amount of solution used while still having the desired dispersibility index. For example, aqueous solutions comprising hydroxylated lecithin material may be used in concentrations up to 30 wt %, or, desirably, 25 wt % to provide a desirable low level of low-shear viscosity. This may be desirable when the process used to coat the particulate protein material is a fluid-bed coating process where very low shear rates are encountered particularly when the solutions are pumped from the coating vessel through peristaltic or other pumps into the spray gun. In this example, the use of the hydroxylated lecithin material may shorten the processing time, reduce solvent (and energy costs) and simplify handling. In one embodiment, any suitable high polarity lecithin material may be used to provide the desired low level of low-shear viscosity.

While not wishing to be bound by theory, it is thought that poor dispersibility of the protein composition may be influenced by the presence of air on the protein particles or agglomerates. The presence of a thick sheet of air on the particle surface may dwarf the somewhat variable contribution of the hydrophilic/hydrophobic surface chemistry and acts as a barrier to water penetration when the protein composition is added to cold water. Hence, it is thought that deaerating and wetting the particles of the protein composition during application of the surfactant may be desirable.

It has been determined that while it may be desirable to lower the surface tension of the air/water interface from its normal value of about 70 dynes/cm in order to displace air with the surfactant, surprisingly, it is not required to lower it to such low levels as have been suggested in the past (e.g., circa 15-25 dynes/cm (oil/water interface) that may result in undesirable flow properties and poor hydratability of the protein composition. It may be sufficient to lower the surface tension to between about 35 dynes/cm and about 50 dynes/cm commonly observed for hydrocarbon/water interfaces. Consequently, increased dispersibility may be obtained without significantly affecting other product attributes by surface coating the protein with a surfactant having a surface tension measured according to Example 1 that is at least about 30 dynes/cm.

High protein content materials with attractive physical properties may be more difficult to produce. The method employed to produce self-wetting soy protein and other food powders can affect the dispersibility properties of the material when fluid-bed coating process conditions (temperature, air flow, solution spray-rate, etc) are poorly understood/controlled or when the process time was shortened too much by increasing solution concentration/spray-rate or when the fluidized protein powder was not efficiently mixing/flowing. Again, while not wishing to be bound by theory, it is thought that when the particulate protein material is coated under some conditions, premature granulation beyond acceptable particle size and entrapment of air in the large agglomerates can result. Air may block access of the coating to the particulate protein material and may be entrapped between the particulate protein material and the coating. When the resulting protein composition is gently stirred into cold water, it is thought that the entrapped sheet of air prevents the particles from dispersing quickly, thus forming lumps or fisheyes, even though the protein composition is granulated.

In one embodiment, the dispersible protein composition may be made by fluidizing the particulate protein material. Typically, the moisture content of the particulate protein material may be about 6%. The process conditions such as air flow and fixing the sample quantity, may be adjusted to accommodate changes due to lot-to-lot variability in protein particle characteristics (size, density, moisture, fines/dust, etc). Any large loosely held agglomerates of the particulate protein material may be broken up due to turbulent flow as well as efficient mixing. In one embodiment, the particle size of the particulate protein material may be between about 10 microns and about 700 microns, or, desirably, between about 25 microns and about 500 microns. In other embodiments, the particle size of the particulate protein material may be at least about 50 microns, or, desirably, at least about 100 microns.

Once, the particulate protein material has been fluidized, it is spray coated using the surfactant solution. The rate at which the solution is spray coated is dependent on the batch size. During spray coating, the incoming air temperature may be below about 70° C., or, desirably, about 60° C. so that the temperature of the particulate protein material is between about 10° C. and about 50° C., or, desirably, between about 15° C. and about 40° C., or, suitably, between about 20° C. and about 30° C. The in-process moisture content of the fluidized particulate protein powder is between about 5 wt % and about 20 wt %, or, desirably, between about 10 wt % and about 15 wt %. Periodically it may be useful to adjust some of the process conditions to ensure that the protein composition is fluidizing and mixing adequately. Should the protein composition appear lumpy or flow poorly the solution spraying may be stopped and the product should be rendered free of flowing/mixing problems. This may be desirable in order to displace the air and uniformly coat the particulate protein material with the surfactant. It may be desirable to avoid excessive granulation.

Once the particulate protein material has been coated, the protein composition may be dried as follows. The inlet air temperature of the air flow may be increased to between about 50° C. and about 70° C., or, desirably, between about 60° C. and about 65° C. The temperature of the protein composition is allowed to increase to between about 30° C. and about 40° C., or, desirably, to about 35° C. The temperature may be maintained at this level for a few minutes until the moisture drops to a specified value, (e.g., 6% (starting material)). Once the moisture level has reached the desired level, then the protein composition may be fluidized for a few more minutes with inlet air heating turned off, and then collected. It should be understood that one skilled in the art may recognize other ways, methods, and apparatuses, that may be used to prepare the protein composition.

### Illustrative Embodiments

According to one embodiment, a dispersible protein composition comprises at least about 85 wt % protein selected from the group consisting of whey protein, soy protein, wheat protein, lupin, corn gluten, and mixtures thereof, lecithin material, and no more than about 0.5 wt % crude fiber. The composition has a dispersibility index of no more than about 12 seconds.

According to another embodiment, a dispersible protein composition comprises at least about 85 wt % protein selected from the group consisting of whey protein, soy protein, wheat protein, lupin, corn gluten, and mixtures thereof and hydroxylated lecithin. The composition has a dispersibility index of no more than about 30 seconds.

According to another embodiment, a dispersible protein composition comprises at least about 85 wt % protein selected from the group consisting of whey protein, soy protein, wheat protein, lupin, corn gluten, and mixtures thereof and lecithin material. The composition has a dispersibility index of no more than about 12 seconds, and the composition has a pile apex angle of at least about 95 degrees.

According to another embodiment, a dispersible protein composition comprises at least about 85 wt % protein selected from the group consisting of whey protein, soy protein, wheat protein, lupin, corn gluten, and mixtures thereof and lecithin material including no more than about 5 wt % oil and having a peak oxidative exotherm index of at least about 15 minutes and an HLB value of at least about 9. The composition has a dispersibility index of no more than about 10 seconds.

According to another embodiment, a dispersible protein composition comprises at least about 90 wt % soy protein and lecithin material including no more than about 5 wt % oil and having a peak oxidative exotherm index of at least about 15 minutes and an HLB value of at least about 9. The composition has a dispersibility index of no more than about 30 seconds.

According to another embodiment, a dispersible protein composition comprises at least about 90 wt % soy protein and hydroxylated lecithin. The composition has a dispersibility index of no more than about 30 seconds.

According to another embodiment, a method of preparing a dispersible protein composition comprises spraying an intermediate particulate protein material with an aqueous solution which comprises a lecithin material to form a wetted protein composition. The particulate protein material is selected from the group consisting of whey protein, soy protein, wheat protein, lupin, corn gluten, and mixtures thereof. The particulate protein composition comprises no more than about 0.5 wt % of crude fiber. The aqueous solution comprises at least about 5 wt % lecithin material. A particulate protein material may be fluidized to provide the intermediate particulate protein composition. The wetted protein composition may be dried to provide an intermediate protein composition. The intermediate protein composition may be fluidized to provide the dispersible protein composition.

According to another embodiment, a method of preparing a dispersible protein composition comprises spraying a particulate protein material with an aqueous solution which comprises hydroxylated lecithin to form a wetted protein composition. The particulate protein material is selected from the group consisting of whey protein, soy protein, wheat protein, lupin, corn gluten, and mixtures thereof. The composition has a dispersibility index of no more than about 30 seconds.

According to another embodiment, a dispersible protein composition prepared by a process comprises spraying a particulate protein material with an aqueous solution comprising hydroxylated lecithin. The particulate protein material includes at least about 90 wt % protein, the protein including whey protein, soy protein, wheat protein, lupin, corn gluten, or a mixture thereof. The particulate protein material may also include at least 75 wt % protein, the protein including whey protein, soy protein, wheat protein, lupin, corn gluten, or a mixture thereof.

### EXAMPLES

The subject matter disclosed herein is further described by reference to the following examples. These examples are meant to illustrate certain aspects of the subject matter disclosed herein and should not be used to limit the scope or interpretation of the claims or other descriptions provided herein.

In the following examples, the lecithin materials used and/or tested were soy lecithin materials unless noted otherwise.

### Example 1

In this example, the surface tension of a number of aqueous solutions containing 2 wt % of lecithin material (prepared by dissolving the lecithin material at 60° C.) was measured. In addition, for one type of lecithin material, the surface tension was measured at 2 wt % as well as 0.5 wt % and 4 wt % concentrations. All of the lecithin materials included no more than about 5 wt % oil (“deoiled lecithin material”). The surface tension was measured using the Wilhelmy method and a digital tensiometer (Kruss, Model K10ST) with a platinum plate at 24° C. A description of the Wilhelmy method may be found in “The Colloidal Domain,” D. F. Evans and H. Wennerstrom, VCH Publishers Inc., New York, 1994, pg. 52. A vertical plate of known perimeter was attached to a balance and the force due to wetting is measured. To avoid contamination, the platinum plate was cleaned using a flame before each solution was tested. Table 1 shows the results for each solution.

TABLE 1

| | | Concen- | Surface |
|---|---|---|---|
| | | tration | Tension |
| Lecithin Material | HLB Value | wt % | (dynes/cm) |
| Sample A (unmodified | 4-6 | 2 | 26.2 |
| lecithin (UL)) | | | |
| Sample B (UL) | 4-6 | 2 | 26.9 |
| Sample C (UL) | 4-6 | 2 | 27.7 |
| Sample D (UL) | 4-6 | 2 | 26 |
| Sample E (UL) | 4-6 | 2 | 25.7 |
| Sample F (UL) | 4-6 | 0.5 | 26.3 |
| Sample F (UL) | 4-6 | 2 | 25.3 |
| Sample F (UL) | 4-6 | 4 | 25 |
| Sample G (Acetylated) | 7-8 | 2 | 33.6 |
| Sample H (Enzyme modified) | 8-9 | 2 | 34.3 |
| Sample I (Hydroxylated) | 10-12 | 2 | 39 |

### Example 2

In this example, 20 kg of soy protein isolate (5.1 wt % moisture) was introduced into a FluidAir Model 150 fluid-bed coater/drier. The initial process conditions were set as follows. Inlet air temperature: 50-60° C.; air flow: 300-350 cubic feet per minute at standard conditions (SCFM); product temperature: 25-30° C.

4 kg of a solution of unmodified (either chemically or enzymatically) lecithin material in water at 10 wt % concentration was spray coated on to the fluidized soy protein isolate powder. The unmodified lecithin material included no more than about 5 wt % oil. The spray coating was done at the following conditions. Inlet air temp: 60° C.; air flow: 350 SCFM; spray air pressure: 45 psi; solution spray rate: 200-230 grams/min; product temperature: 25-30° C.; equilibrium moisture content: 10-13%.

A small sample was removed after depositing 1 wt % lecithin material based on the total dry weight of the resulting protein composition. After all the solution was deposited, i.e., 2 wt % lecithin material based on the total dry weight of the resulting protein composition, the moisture content was measured as 11.1 wt %. The protein composition was dried with an inlet air temp at 60-65° C. until the composition's temperature increased to 35° C. After maintaining the protein composition's temperature at 35° C., a sample was removed and the moisture content was measured as 6 wt %. The composition was fluidized with the inlet air heater turned off for 2 min and transferred out of the fluid-bed container.

### Example 3

The dispersibility index for the protein composition having 1 wt % of lecithin material and the protein composition having 2 wt % lecithin material prepared as described in Example 2 was measured as follows. A level teaspoon of the powdered protein composition was dropped onto the surface of 200 ml water in a 250 ml beaker. The spoon was used to gently stir the mixture in a rhythm of 5 turns clockwise followed by 5 turns counterclockwise, repeated until the powder is completely dispersed in the water and clumps do not float to the surface. The time from the beginning of stirring until complete dispersion was measured and recorded. The average of two tests according to this procedure are what is referred to herein as the “dispersibility index.” A comparison is shown of the protein compositions from Example 2 in Table 2. If more than 120 seconds elapses before complete dispersion, 120+ is recorded and this is considered very poorly dispersible material.

TABLE 2

| | Dispersibility |
|---|---|
| Sample | Index (sec) |
| Untreated soy protein isolate | 120+ |
| Soy protein isolate + 1% unmodified lecithin material | 5.5 |
| Soy protein isolate + 2% unmodified lecithin material | 3.5 |

### Example 4

In this example, the unmodified lecithin material from Example 2 was substituted with a hydroxylated lecithin material (available under the trade name Precept 8120; obtained from Central Soya, Fort Wayne, Ind.) and the same procedure was followed. The hydroxylated lecithin material included no more than about 5 wt % of oil. Samples of the protein composition were removed after coating the soy protein isolate with 0.5 wt %, 1.0 wt %, and 1.5 wt % of the hydroxylated lecithin material based on total weight of the resulting protein composition. The final protein composition was collected after coating the soy protein isolate with 2 wt % hydroxylated lecithin material. The dispersibility index for each sample is shown in Table 3.

TABLE 3

| | Dispersibility |
|---|---|
| Sample | index (sec) |
| Untreated soy protein isolate | 120+ |
| Soy protein isolate + 0.5 wt % hydroxylated lecithin | 4.5 |
| material | |
| Soy protein isolate + 1.0 wt % hydroxylated lecithin | 3.0 |
| material | |
| Soy protein isolate + 1.5 wt % hydroxylated lecithin | 4.5 |
| material | |
| Soy protein isolate + 2.0 wt % hydroxylated lecithin | 3.0 |
| material | |

### Example 5

50 grams of soy protein isolate was fluidized and coated with an aqueous solution having 10 wt % hydroxylated lecithin material using the Vector MFL-01 Laboratory fluid bed coater equipped with a bottom-spray Wurster column for uniform film formation on the soy protein isolate particles. The hydroxylated lecithin material included no more than about 5 wt % of oil. The temperature of the aqueous solution was about 80° C., the inlet and exhaust air temperatures were 90° C. and 32° C., respectively, and the flow rates (air and solution spray) were set at near maximum. At a coating rate of about 1.5-2.0 grams of solution per minute the solution coated well without causing excessive agglomeration. Samples of the protein composition with 1 wt % and 2 wt % hydroxylated lecithin material were obtained for dispersibility testing. The resulting protein composition powders were dry, free flowing and devoid of fines. Seven commercially available soy protein isolate products coated with lecithin material according to conventional techniques and formulations were also tested for dispersibility using the procedure described in Example 3. The results are shown in Table 4.

TABLE 4

| | Dispersibility |
|---|---|
| Sample | index (sec) |
| Untreated soy protein isolate | 120+ |
| Soy protein isolate + 1.0 wt % hydroxylated lecithin | 60 |
| material | |
| Soy protein isolate + 2.0 wt % hydroxylated lecithin | 3 |
| material | |
| Supro 670 | 45 |
| Supro 710 | 22 |
| FP 940 | 18 |
| Profam 982 | 30 |
| Profam 974 | 25 |
| Profam 930 | 22 |
| Profam 891 | 80 |

### Example 6

In this example, three protein composition samples were prepared according to Example 5 on a different day from the day when the samples in Example 5 were prepared. Each of the three additional samples (Samples 6A-6C) was coated with 2 wt % hydroxylated lecithin material. The results of dispersibility testing according to Example 3 are shown in Table 5.

TABLE 5

| | Dispersibility |
|---|---|
| Sample | index (sec) |
| Untreated soy protein isolate | 120+ |
| 6A - Soy protein isolate + 2.0 wt % hydroxylated | 2 |
| lecithin material | |
| 6B - Soy protein isolate + 2.0 wt % hydroxylated | 1 |
| lecithin material | |
| 6C - Soy protein isolate + 2.0 wt % hydroxylated | 1 |
| lecithin material | |

### Example 7

Four additional samples were prepared according to the procedure described in Example 6 except that the soy protein isolate used to prepare the four samples had a bulk density of 26.3 g/100 mL compared to 34.2 g/100 mL in Example 6 and a mean particle size of 77 microns compared to 250 microns in Example 6. The particle size of the soy protein isolate was measured using the Cilas 1064 laser particle size analyzer available from Cilas U.S., Inc., 11420 Fortune-Circle Suite I-14, Wellington, Fla. 33414. In two of the four samples, the hydroxylated lecithin used in Example 6 was substituted with unmodified lecithin material including no more than about 5 wt % oil (“deoiled lecithin material”) in one sample and unmodified lecithin material including at least about 35 wt % oil (“fluid grade lecithin material”) in the other sample. The results of dispersibility testing of the four samples are shown in Table 6.

TABLE 6

| | Dispersibility |
|---|---|
| Sample | index (sec) |
| Untreated soy protein isolate | 120+ |
| Soy protein isolate + 2.0 wt % hydroxylated lecithin | 6 |
| material | |
| Soy protein isolate + 2.0 wt % hydroxylated lecithin | 4 |
| material | |
| Soy protein isolate + 2.0 wt % deoiled lecithin | 20 |
| material | |
| Soy protein isolate + 2.0 wt % fluid grade lecithin | 22 |
| material | |

### Example 8

In this example, one sample was prepared according to Example 6. Two additional samples were prepared according to Example 6 except that in one sample the soy protein isolate was substituted with whey protein isolate and in the other sample the soy protein isolate was substituted with sodium caseinate. The results of dispersibility testing for the three samples are shown in Table 7.

TABLE 7

| | Dispersibility |
|---|---|
| Sample | index (sec) |
| Untreated soy protein isolate | 120+ |
| Soy protein isolate + 2.0 wt % hydroxylated | 4.5 |
| lecithin material | |
| Untreated whey protein isolate | 120+ |
| Whey protein isolate + 2.0 wt % hydroxylated | 4.0 |
| lecithin material | |
| Untreated sodium caseinate | 120+ |
| Sodium caseinate + 2.0 wt % hydroxylated | 120+ |
| lecithin material | |

### Example 9

The oxidative stability of various lecithin materials was determined using ASTM method “D6186-98—Standard Test Method for Oxidation Induction Time of Lubricating Oils by Pressure Differential Scanning Calorimetry (PDSC).” In this test, the lecithin materials were subjected to elevated temperature (140° C.) and pressure (500 psi) in a pure oxygen atmosphere to cause oxidative events to occur. The oxidative events are exothermic and can be detected by the Differential Scanning Calorimeter. As referred to herein, the “oxidative induction index” is determined by how long it takes for the onset of the exothermic event after the PDSC cell has reached the specified conditions. The term “peak oxidative exotherm index” is determined by how long it takes to reach the maxima of the oxidation exotherm curve under the conditions described above.

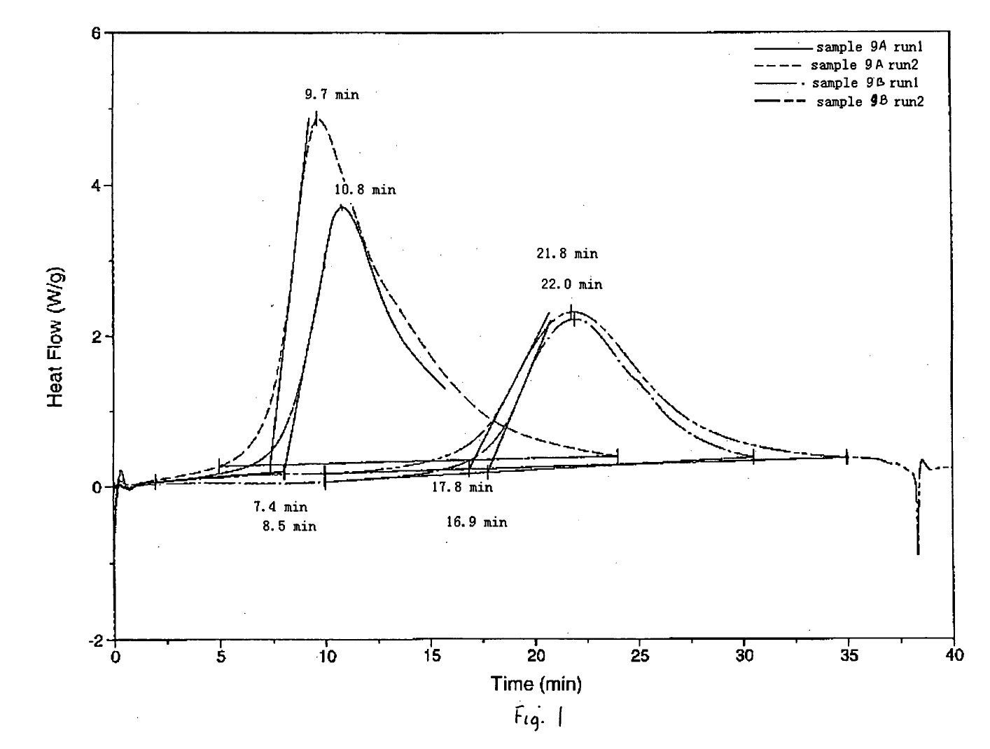

A number of different lecithin materials were tested. All of the various lecithin materials tested in this example included no more than about 5 wt % oil (“deoiled lecithin material”). The results for two lecithin materials are shown in FIG. 1 while the results for an additional five lecithin materials are shown in Table 8.

The results shown in FIG. 1 are for an unmodified lecithin material (Samples 9A) and a hydroxylated lecithin material (Sample 9B). The test was performed twice for each lecithin material. While not wishing to be bound by theory, it would be expected that the hydroxylated lecithin material would be more oxidatively stable due to less double bonds in the material. Of course, other parameters may also affect oxidative stability (e.g., shelf life, additives/stabilizers such as antioxidants, metal sequestrants, etc.).

As shown in FIG. 1, the oxidative induction index for runs 1 and 2 of the unmodified lecithin material (Sample 9A) was about 8.5 minutes and about 7.4 minutes, respectively. The oxidative induction index for runs 1 and 2 of the hydroxylated lecithin material (Sample 9B) was about 17.8 minutes and about 16.9 minutes, respectively. The peak oxidative exotherm index for runs 1 and 2 of the unmodified lecithin material (Sample 9A) was about 10.8 minutes and about 9.7 minutes, respectively. The peak oxidative exotherm index for runs 1 and 2 of the hydroxylated lecithin material (Sample 9B) was about 22.0 minutes and about 21.8 minutes, respectively.

Five other lecithin materials were tested according to this method. The results of the tests are shown in Table 8.

TABLE 8

| | Oxidative | Peak |
|---|---|---|
| Sample | Induction | Oxidative |
| (all samples include no more than about | Index | Exotherm |
| 5 wt % oil) | (min) | Index (min) |
| 9A - unmodified lecithin material run 1 | 8.5 | 10.8 |
| 9A - unmodified lecithin material run 2 | 7.4 | 9.7 |
| 9B - Hydroxylated lecithin material run 1 | 17.8 | 22.0 |
| 9B - Hydroxylated lecithin material run 2 | 16.9 | 21.8 |
| 9C - unmodified lecithin material | 1.8 | 5.4 |
| 9D - unmodified lecithin material | 7.1 | 9.6 |
| 9E - unmodified lecithin material | 8.6 | 11.3 |
| 9F - Enzyme modified lecithin material | 11.8 | 13.3 |
| 9G - Acetylated lecithin material | 14.4 | 14.9 |

### Example 10

The flowability of the protein composition prepared according to Example 5 was compared to the flowability of Supro 670. The flowability of each sample was measured in duplicate as follows.

10 g of each sample was placed into a 145 mm polyethylene funnel with a 14 mm orifice plugged with a rubber stopper. The funnel was tapped a few times to level the surface of the sample, then the stopper was removed. The sample was allowed to fall onto a clean sheet of paper with gentle tapping to facilitate the flow of the sample. The distance from the bottom of the funnel to the surface was 90 mm. A mark was made on the paper on each side of the pile. The distance between the marks were later measured with a ruler. As used herein, the term “pile spread diameter” refers to the distance between the marks obtained according to the procedure described in this example.

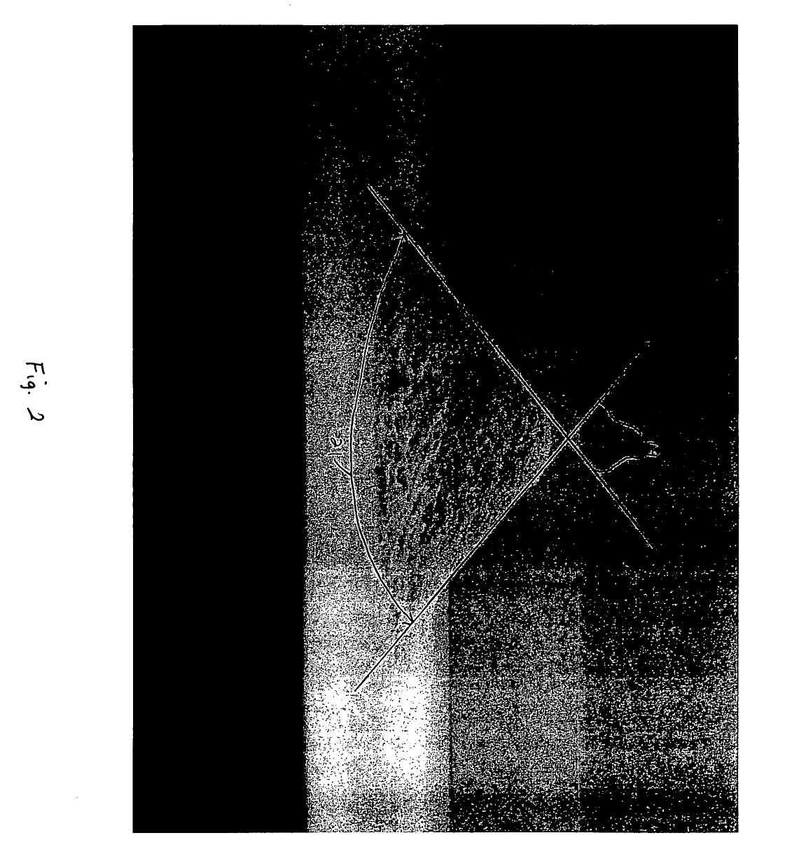

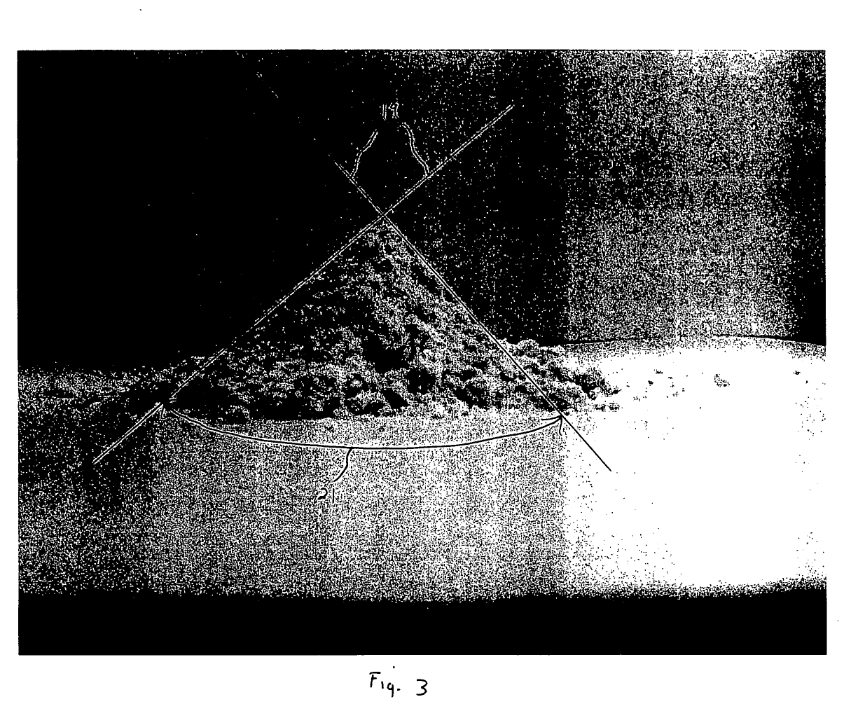

While the pile was still on the paper, a photograph of the pile was taken from a relatively flat angle relative to the surface (nearly parallel to the surface). The photograph was printed and the tangents 19 (FIGS. 2 and 3) to the pile at the top half of the pile were drawn onto the printed photograph. The angle (shown in FIGS. 2 and 3 using reference numeral 21) between the tangents was determined using a protractor. As used herein, the term “pile apex angle” refers to the angle measured according to the procedure described in this example.

With reference to FIG. 2, one example of a pile prepared according to this procedure using the protein composition prepared according to the procedure described in Example 5 is shown. Desirably, the pile is a substantially uniform conical shape and composed of a plurality of particles that are substantially similar in size. The pile spread diameter was 95 mm and the pile apex angle was 102 degrees.

In contrast, one example of a pile of Supro 670 prepared according to the procedure described above is shown in FIG. 3. The pile shown in FIG. 3 includes a number of clumps and tends to pile up higher. The pile spread diameter was 82 mm and the pile apex angle was 90 degrees.

Terms used in the specification and claims such as have, having, include, and including should be construed to be synonymous with the terms comprise and comprising. Also, unless otherwise indicated, all numbers or expressions, such as those expressing dimensions, physical characteristics, etc. used in the specification are understood as modified in all instances by the term “about”. At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of “1 to 10” should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

1. A dispersible protein composition comprising:
at least about 85 wt % protein, wherein the protein includes at least about 75 wt % whey protein, soy protein, wheat protein, lupin, corn gluten, or a mixture thereof;
lecithin material; and
no more than about 0.5 wt % crude fiber;
wherein the composition has a dispersibility index of no more than about 12 seconds.

2. The dispersible protein composition according to claim 1 wherein the lecithin material comprises hydroxylated lecithin.

3. The dispersible protein composition according to claim 1 comprising at least about 90 wt % protein.

4. The dispersible protein composition according to claim 1 wherein the protein comprises soy protein.

5. The dispersible protein composition according to claim 1 wherein the lecithin material includes no more than about 5 wt % oil.

6. The dispersible protein composition according to claim 5 wherein the lecithin material has a peak oxidative exotherm index of at least about 18 minutes.

7. The dispersible protein composition according to claim 5 wherein the lecithin material has an HLB value of at least about 9.

8. The dispersible protein composition according to claim 1 wherein the lecithin material has a surface tension index of at least about 30 dynes/cm.

9. The dispersible protein composition according to claim 1 wherein the composition has a pile apex angle of at least about 95 degrees.

10. The dispersible protein composition according to claim 1 wherein the composition has a pile spread diameter of at least about 90 mm.

11. The dispersible protein composition according to claim 1 comprising no more than about 0.5% of not readily digestible carbohydrates.

12. The dispersible protein composition according to claim 1 wherein the dispersible protein composition has a mean particle size between about 25 microns and about 500 microns.

13. The dispersible protein composition according to claim 1 comprising about 0.5 wt % to 5 wt % hydroxylated lecithin.

14. A dispersible protein composition comprising:
at least about 85 wt % protein, wherein the protein includes at least about 75 wt % whey protein, soy protein, wheat protein, lupin, corn gluten, or a mixture thereof; and
hydroxylated lecithin;
wherein the composition has a dispersibility index of no more than about 30 seconds.

15. The dispersible protein composition according to claim 14 wherein the composition has a dispersibility index of no more than about 10 seconds.

16. The dispersible protein composition according to claim 14 wherein the protein comprises soy protein.

17. The dispersible protein composition according to claim 14 wherein the composition has a pile apex angle of at least about 95 degrees.

18. The dispersible protein composition according to claim 14 comprising at least about 90 wt % protein.

19. A dispersible protein composition comprising:
at least about 85 wt % protein, wherein the protein includes at least about 75 wt % whey protein, soy protein, wheat protein, lupin, corn gluten, or a mixture thereof; and
lecithin material;
wherein the composition has a dispersibility index of no more than about 10 seconds and a pile apex angle of at least about 95 degrees.

20. The dispersible protein composition according to claim 19 wherein the composition has a pile spread diameter of at least about 90 mm.

21. The dispersible protein composition according to claim 19 wherein the lecithin material comprises hydroxylated lecithin.

22. The dispersible protein composition according to claim 19 comprising about 0.5 wt % to 5 wt % lecithin.

23. The dispersible protein composition according to claim 22 wherein the lecithin material has a peak oxidative exotherm index of at least about 15 minutes.

24. The dispersible protein composition according to claim 19 wherein the lecithin material has a surface tension index of at least about 30 dynes/cm.

25. The dispersible protein composition according to claim 19 where the dispersible protein composition has a mean particle size of about 25 microns to 500 microns.

26. A dispersible protein composition comprising:
at least about 85 wt % protein, wherein the protein includes at least about 75 wt % whey protein, soy protein, wheat protein, lupin, corn gluten, or a mixture thereof; and
lecithin material including no more than about 5 wt % oil and having a peak oxidative exotherm index of at least about 15 minutes and an HLB value of at least about 9;
wherein the composition has a dispersibility index of no more than about 10 seconds.

27. The dispersible protein composition according to claim 26 wherein the lecithin material comprises hydroxylated lecithin.

28. The dispersible protein composition according to claim 26 wherein the composition has a pile apex angle of at least about 95 degrees.

29. The dispersible protein composition according to claim 26 wherein the lecithin material has a surface tension index of at least about 30 dynes/cm.

30. A dispersible protein composition comprising:
at least about 90 wt % soy protein; and
lecithin material having a peak oxidative exotherm index of at least about 15 minutes and a surface tension index of at least about 30 dynes/cm;
wherein the composition has a dispersibility index of no more than about 30 seconds.

31. The dispersible protein composition according to claim 30 wherein the composition has a dispersibility index of no more than about 10 seconds.

32. The dispersible protein composition according to claim 30 comprising no more than about 0.5 wt % crude fiber.

33. The dispersible protein composition according to claim 30 wherein the composition has a pile apex angle of at least about 95 degrees.

34. The dispersible protein composition according to claim 30 wherein the lecithin material comprises hydroxylated lecithin.

35. The dispersible protein composition according to claim 30 wherein the lecithin material has an HLB value of at least about 9.

36. The dispersible protein composition according to claim 30 wherein the lecithin material has a peak oxidative exotherm index of at least about 20 minutes.

37. A method of preparing a dispersible protein composition comprising:
spraying a particulate protein material with an aqueous solution which comprises a lecithin material to form a wetted protein material;
wherein the particulate protein material is includes at least about 75 wt % whey protein, soy protein, wheat protein, lupin, corn gluten, or mixtures thereof; and the particulate protein material comprises no more than about 0.5 wt % of crude fiber; and the aqueous solution comprises at least about 5 wt % lecithin material.

38. The method according to claim 37 further comprising fluidizing the particulate protein material.

39. The method according to claim 37 further comprising drying the wetted protein material to provide a dried lecithin treated protein material.

40. The method according to claim 39 comprising drying the wetted protein material at a temperature of no more than about 40° C.

41. The method according to claim 37 wherein the particulate protein material comprises at least about 90 wt % protein.

42. The method according to claim 37 wherein the lecithin material comprises hydroxylated lecithin.

43. A method of preparing a dispersible protein composition comprising:
spraying a particulate protein material with an aqueous solution which comprises hydroxylated lecithin to form a wetted protein material;
wherein the particulate protein material includes at least about 75 wt % whey protein, soy protein, wheat protein, lupin, corn gluten, or a mixture thereof; and the dispersible protein composition has a dispersibility index of no more than about 30 seconds.

44. The method according to claim 43 wherein the aqueous solution comprises at least about 5 wt % hydroxylated lecithin.

45. The method according to claim 43 further comprising fluidizing the particulate protein material.

46. The method according to claim 43 comprising drying the wetted protein material to provide a dried hydroxylated lecithin-treated protein material.

47. The method according to claim 46 further comprising fluidizing the dried hydroxylated lecithin-treated protein material.

48. A dispersible protein composition prepared by a process comprising:
spraying a particulate protein material with an aqueous solution comprising hydroxylated lecithin;
wherein the particulate protein material includes at least about 90 wt % protein and the protein includes whey protein, soy protein, wheat protein, lupin, corn gluten, or a mixture thereof.
